(19) United States
(12) Patent Application Publication
(10) Pub. No.: US 2026/0158512 A1
(43) Pub. Date: Jun. 11, 2026

(54) SHOWERHEAD WITH WATER OUTPUT ANGLE CONTROL

(71) Applicant: Kohler Mira Limited, Cheltenham (GB)

(72) Inventors: Benjamin Lea, Cheltenham (GB); Colin Beattie, Cheltenham (GB); Oliver Jones, Cheltenham (GB); Simon Westgate, Cheltenham (GB)

(21) Appl. No.: 19/407,225

(22) Filed: Dec. 3, 2025

(30) Foreign Application Priority Data
Dec. 6, 2024 (GB) 2147909.5

(51) Int. Cl. B05B 12/16; B05B 1/02

(52) U.S. Cl. CPC B05B 12/16; B05B 1/02

(57) ABSTRACT

A showerhead having first and second water inlets and a number of nozzles is provided. Each nozzle has a first nozzle inlet, a second nozzle inlet, a nozzle outlet, a first nozzle channel connecting the first nozzle inlet with the nozzle outlet, and a second nozzle channel connecting the second nozzle inlet with the nozzle outlet. The first nozzle channel is at an angle β to the second nozzle channel. For each nozzle, a first enclosed space connects the first water inlet to the first nozzle inlet , and a second enclosed space connects the second water inlet to the second nozzle inlet . The output angle α with respect to an axis A through a nozzle of the water flowing from each nozzle outlet depends on water entering the nozzle from only the first nozzle inlet, from only the second nozzle inlet, or from both nozzle inlets.

This application claims priority to UK Application No. 2147909.5, filed December 6, 2024, the entirety of which is hereby incorporated by reference.

### Field of the Invention

The present disclosure relates generally to showerheads, and methods for controlling an output angle of water flowing out from showerheads.

### BACKGROUND OF THE INVENTION

Showerheads that provide different flow streams and spray patterns are popular among users.

### Brief Summary of the Invention

In prior art showerheads, users have been able to select between different flow streams and spray patterns. However, there is a need for a showerhead that enables a user to easily select between different output angles of water flowing out from a showerhead.

### BRIEF DESCRIPTION OF THE DRAWINGS

FIG. 1 illustrates an example showerhead, in accordance with one or more embodiments described herein.

FIGS. FIGS. 2a-b and 3a-b illustrate cross-sections of an example showerhead, in accordance with one or more embodiments described herein.

FIGS. 4a-b illustrate example layers, in accordance with one or more embodiments described herein.

FIGS. 5a-b illustrate example layers and nozzles, in accordance with one or more embodiments described herein.

FIGS. 6a-c illustrate example nozzles, in accordance with one or more embodiments described herein.

FIGS. 7a-c schematically illustrate example shower spray patterns, in accordance with one or more embodiments described herein.

FIG. 8 schematically illustrates an example method for controlling an output angle of water flowing out from a showerhead, in accordance with one or more embodiments described herein.

Embodiments of the present disclosure and their advantages are best understood by referring to the detailed description that follows. It should be appreciated that like reference numerals are used to identify like elements illustrated in one or more of the figures.

### DETAILED DESCRIPTION

In prior art showerheads, users have been able to select between different flow streams and spray patterns. However, there is a need for a showerhead that enables a user to easily select between different output angles of water flowing out from a showerhead.

The present disclosure is disclosed in the context of showerhead or shower systems but is not limited to showerheads or shower systems. Aspects of the present disclosure that are depicted in the illustrated embodiments or otherwise described herein may be used in conjunction with other ablutionary fittings or water distribution systems. Water distribution systems encompassed by the present disclosure include, without limitation, water distribution systems that dispense water for consumption and/or washing and water distribution systems used for private, public, domestic, residential, commercial, and/or industrial use. Water distribution systems such as, for example and without limitation, showers, baths, washtubs, hot tubs, sinks, fountains, water dispensers, and the like may incorporate aspects of the present disclosure and are encompassed herein. Example water distribution systems may include an outlet dispensing water or other fluid. The outlet may include any suitable device that is configured to dispense liquid or water. The outlet may include an ablutionary fitting, such as, for example and without limitation, a showerhead, shower spray, wand hand shower, faucet, wand, spigot, tap, spout, or the like. The outlet can include a single outlet or more than one outlet. Where the outlet includes multiple, e.g., two or more outlets, the outlets can be similar types of outlets or dissimilar types of outlets. Elements and features described with reference to one illustrated embodiment are not limited to that embodiment only; the features and elements of any one or more of the illustrated embodiments can be utilized in any other embodiment in any combination.

In an example embodiment, a showerhead may include a first water inlet, a second water inlet, and a number of nozzles. Each nozzle may have a first nozzle inlet, a second nozzle inlet, a nozzle outlet, a first nozzle channel, connecting the first nozzle inlet with the nozzle outlet, and a second nozzle channel, connecting the second nozzle inlet with the nozzle outlet. The first nozzle channel may be arranged at an angle β (=β₁+β₂) to the second nozzle channel. A first enclosed space, transversally arranged within the showerhead, may directly connect the first water inlet to the first nozzle inlet of each nozzle, and a second enclosed space, transversally arranged within the showerhead, may directly connect the second water inlet to the second nozzle inlet of each nozzle. The nozzles may be configured so that the output angle α with respect to an axis A through the nozzle of the water flowing out from each nozzle outlet depends on whether water enters the nozzle from only the first nozzle inlet, from only the second nozzle inlet, or from both nozzle inlets. This may assist a user with selecting between different angles of the water output from the nozzles, and thereby between different spray patterns.

In an example embodiment, all nozzles are arranged with the same one nozzle channel closer to a central area of the lower layer than the same other nozzle channel. When water is supplied to only the first water inlet, and thereby to the first nozzle channel of all nozzles, the output angle of water flowing out from the showerhead may be directed outwards from the central area of the lower layer, thus creating a wide shower spray pattern. When water is supplied to only the second water inlet, and thereby to the second nozzle channel of all nozzles, the output angle of water flowing out from the showerhead may be directed inwards toward the central area of the lower layer, thus creating a focused shower spray pattern. If water is supplied to both the first water inlet and the second water inlet, water may instead flow substantially straight out from the showerhead.

In an example embodiment, if water enters the nozzle from only the first nozzle inlet, the output angle α with respect to the axis A through the nozzle of the water flowing out from the nozzle outlet substantially corresponds to a channel angle β₁ of the first nozzle channel with respect to the axis A through the nozzle; if water enters the nozzle from only the second nozzle inlet, the output angle α with respect to the axis A through the nozzle of the water flowing out from the nozzle outlet substantially corresponds to a channel angle β₂ of the second nozzle channel with respect to the axis A through the nozzle; and if water enters the nozzle from both the first nozzle inlet and the second nozzle inlet, the output angle α with respect to the axis A through the nozzle of the water flowing out from the nozzle outlet is smaller than both the channel angle β₁ of the first nozzle channel and the channel angle β₂ of the second nozzle channel.

In an example embodiment, if water enters the nozzle from both the first nozzle inlet and the second nozzle inlet, the water flowing out from the nozzle outlet is substantially parallel to the axis A through the nozzle.

In an example embodiment, each nozzle includes a flow divider, which separates the first and second nozzle channels, and helps prevent water entering the first nozzle inlet from entering the second nozzle channel, and that water entering the second nozzle inlet cannot enter the first nozzle channel. This may help prevent water supplied to the first water inlet from contaminating water supplied to the second water inlet, or the other way around.

In an example embodiment, the showerhead includes an upper layer, an intermediate layer, and a lower layer, and the first enclosed space is formed between the upper layer and the intermediate layer, and the second enclosed space is formed between the intermediate layer and the lower layer (or the other way around). The intermediate layer and the lower layer may both be disc-shaped. This helps to enable the formation of the first enclosed space between the upper layer and the intermediate layer, and the second enclosed space between the intermediate layer and the lower layer (or the other way around). The different layers do not have to be separate constructions, two or more of them may be integral in one piece, but each layer extends transversally across the showerhead so that the first and second enclosed spaces are able to connect the first and second water inlets with the first and second nozzle inlets (of all nozzles having two inlets). There may also be more layers in the showerhead.

In an example embodiment, the first nozzle inlets are integrated into the intermediate layer, and the second nozzle inlets are integrated into the lower layer (or the other way around). This connects the first nozzle inlets to the first enclosed space, and the second nozzle inlets to the second enclosed space (or the other way around). The flow divider may be integrated into either the intermediate layer or the lower layer.

An example ablutionary system may include the above described showerhead and a diverter arrangement. The diverter arrangement may be configured to be controllable to direct water to the first water inlet, to the second water inlet, or to both water inlets.

In an example embodiment, the diverter arrangement is integrated into the showerhead, and is arranged to be controlled by a mechanism arranged on the showerhead. Alternatively, the diverter arrangement may be arranged remotely from the showerhead. The diverter arrangement may in embodiments be a digital valve in a shower control system.

An example method for controlling an output angle of water flowing out from a showerhead of an ablutionary system may include: arranging a number of nozzles in the showerhead, where each nozzle is configured to have: a first nozzle inlet; a second nozzle inlet; a nozzle outlet; a first nozzle channel, connecting the first nozzle inlet with the nozzle outlet; and a second nozzle channel, arranged at an angle β (=β₁+β₂) to the first nozzle channel, and connecting the second nozzle inlet with the nozzle outlet; arranging the showerhead to have a first enclosed space, transversally arranged within the showerhead; arranging the showerhead to have a second enclosed space, transversally arranged within the showerhead; arranging the first enclosed space to directly connect a first water inlet of the showerhead to the first nozzle inlet of each nozzle; arranging the second enclosed space to directly connect a second water inlet of the showerhead to the second nozzle inlet of each nozzle; and controlling a diverter arrangement of the ablutionary system to allow water to flow into the showerhead from the first water inlet, and thereby into the first nozzle inlet, and/or from the second water inlet, and thereby into the second nozzle inlet. The output angle α with respect to an axis A through the nozzle of the water flowing out from each nozzle outlet may depend on whether water enters the nozzle from only the first nozzle inlet, from only the second nozzle inlet, or from both nozzle inlets. This may assist a user with selecting between different angles of the water output from the nozzles, and thereby between different spray patterns.

In an example embodiment, the method further includes arranging all nozzles in the showerhead with the same one nozzle channel closer to a central area of the lower layer than the same other nozzle channel. When water is supplied to only the first water inlet, and thereby to the first nozzle channel of all nozzles, the output angle of water flowing out from the showerhead will be directed outwards from the central area of the lower layer, thus creating a wide shower spray pattern. When water is supplied to only the second water inlet, and thereby to the second nozzle channel of all nozzles, the output angle of water flowing out from the showerhead will be directed inwards toward the central area of the lower layer, thus creating a focused shower spray pattern. If water is supplied to both the first water inlet and the second water inlet, water may instead flow substantially straight out from the showerhead.

In an example embodiment, if water enters the nozzle from only the first nozzle inlet, the output angle α with respect to the axis A through the nozzle of the water flowing out from the nozzle outlet substantially corresponds to a channel angle β₁ of the first nozzle channel with respect to the axis A through the nozzle. If water enters the nozzle from only the second nozzle inlet, the output angle α with respect to the axis A through the nozzle of the water flowing out from the nozzle outlet substantially corresponds to a channel angle β₂ of the second nozzle channel with respect to the axis A through the nozzle. If water enters the nozzle from both the first nozzle inlet and the second nozzle inlet, the output angle α with respect to the axis A through the nozzle of the water flowing out from the nozzle outlet is smaller than both the channel angle β₁ of the first nozzle channel and the channel angle β₂ of the second nozzle channel. However, if the pressure of the water supplied to the either of the nozzle inlets is low, gravity may affect the output angles.

In an example embodiment, if water enters the nozzle from both the first nozzle inlet and the second nozzle inlet, the water flowing out from the nozzle outlet is substantially parallel to the axis A through the nozzle. This may be the case at least if the channel angle β₁ is substantially the same as the channel angle β₂, and the pressure of the water supplied to the first nozzle inlet is substantially the same as the pressure of the water supplied to the second nozzle inlet.

In an example embodiment, the method further includes forming the first enclosed space between an upper layer and an intermediate layer of the showerhead, and forming the second enclosed space between the intermediate layer and a lower layer of the showerhead (or the other way around). The method may further include arranging the intermediate layer and the lower layer to both be disc-shaped. This helps to enable the formation of the first enclosed space between the upper layer and the intermediate layer, and the second enclosed space between the intermediate layer and the lower layer (or the other way around). The different layers do not have to be separate constructions, two or more of them may be integral in one piece, but each layer extends transversally across the showerhead so that the first and second enclosed spaces are able to connect the first and second water inlets with the first and second nozzle inlets (of all nozzles having two inlets). There may also be more layers in the showerhead.

In an example embodiment, the method further includes arranging each nozzle to include a flow divider, which separates the first and second nozzle channels, and helps prevent water entering the first nozzle inlet from entering the second nozzle channel, and that water entering the second nozzle inlet cannot enter the first nozzle channel. This may help prevent water supplied to the first water inlet from contaminating water supplied to the second water inlet, or the other way around.

In an example embodiment, the method further includes integrating the first nozzle inlets into the intermediate layer, and integrating the second nozzle inlets into the lower layer. This connects the first nozzle inlets to the first enclosed space, and the second nozzle inlets to the second enclosed space. The flow divider may be integrated into either the intermediate layer or the lower layer.

In an example embodiment, the first enclosed space and the second enclosed space are both substantially parallel with a bottom layer of the showerhead, through which the nozzles extend.

The showerhead may additionally have other nozzles, which do not have first and second nozzle inlets connected to the first and second water inlets.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

The present disclosure relates generally to showerheads and methods for controlling an output angle of water flowing out from showerheads. Embodiments of the disclosed solution are presented in more detail in connection with the figures.

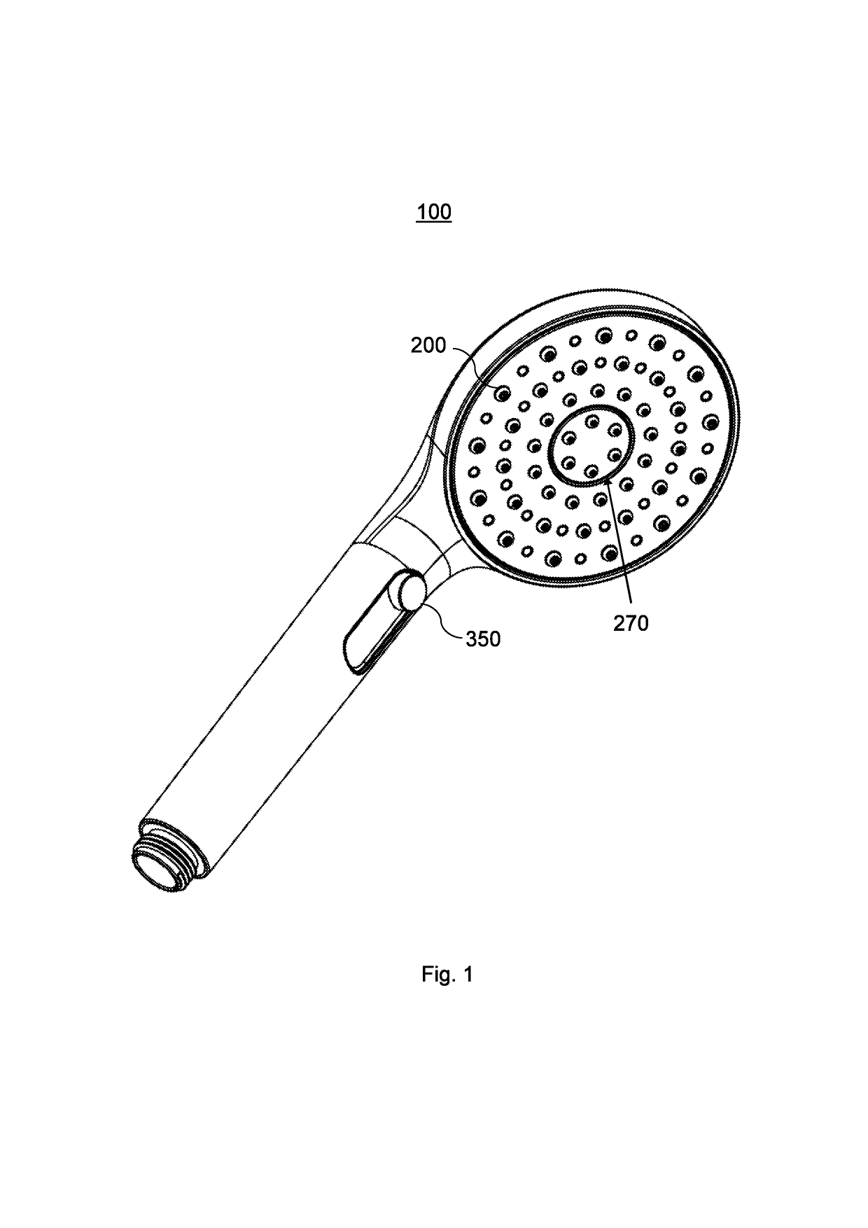

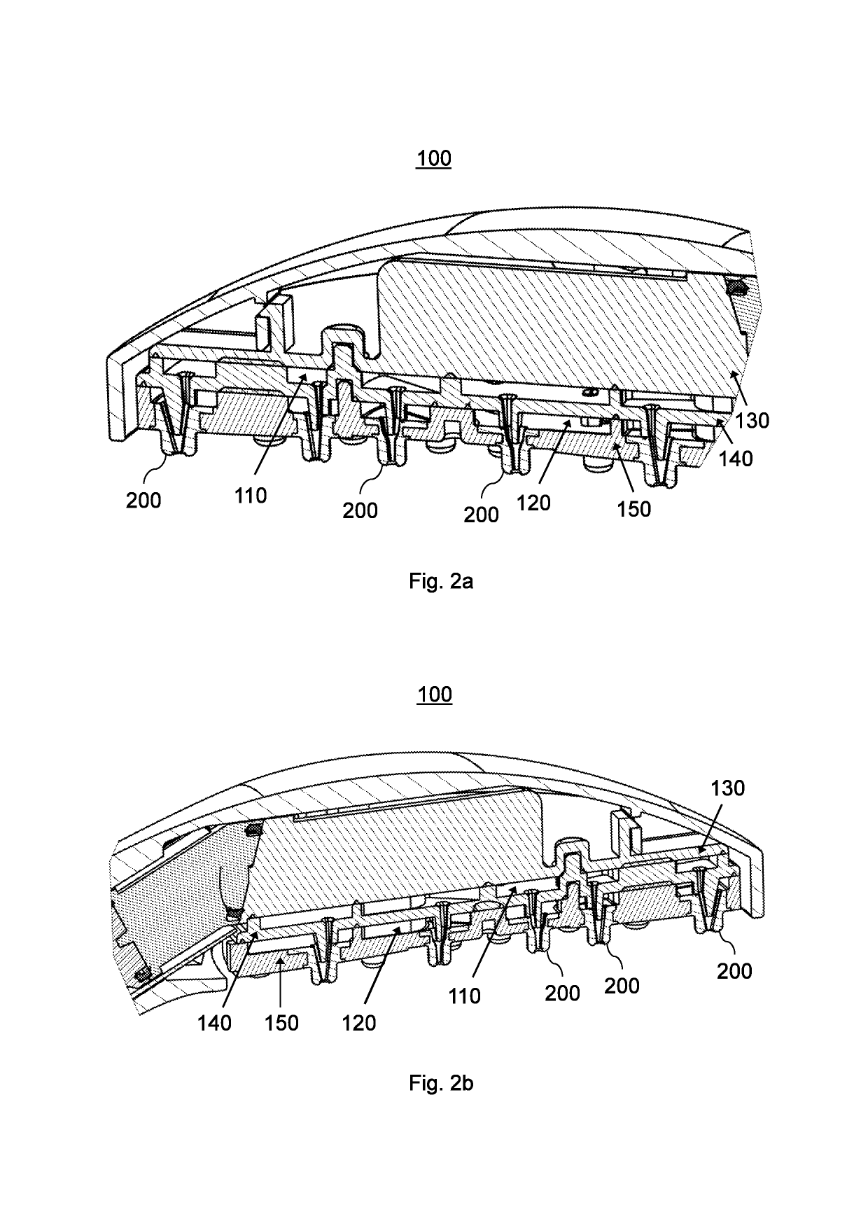

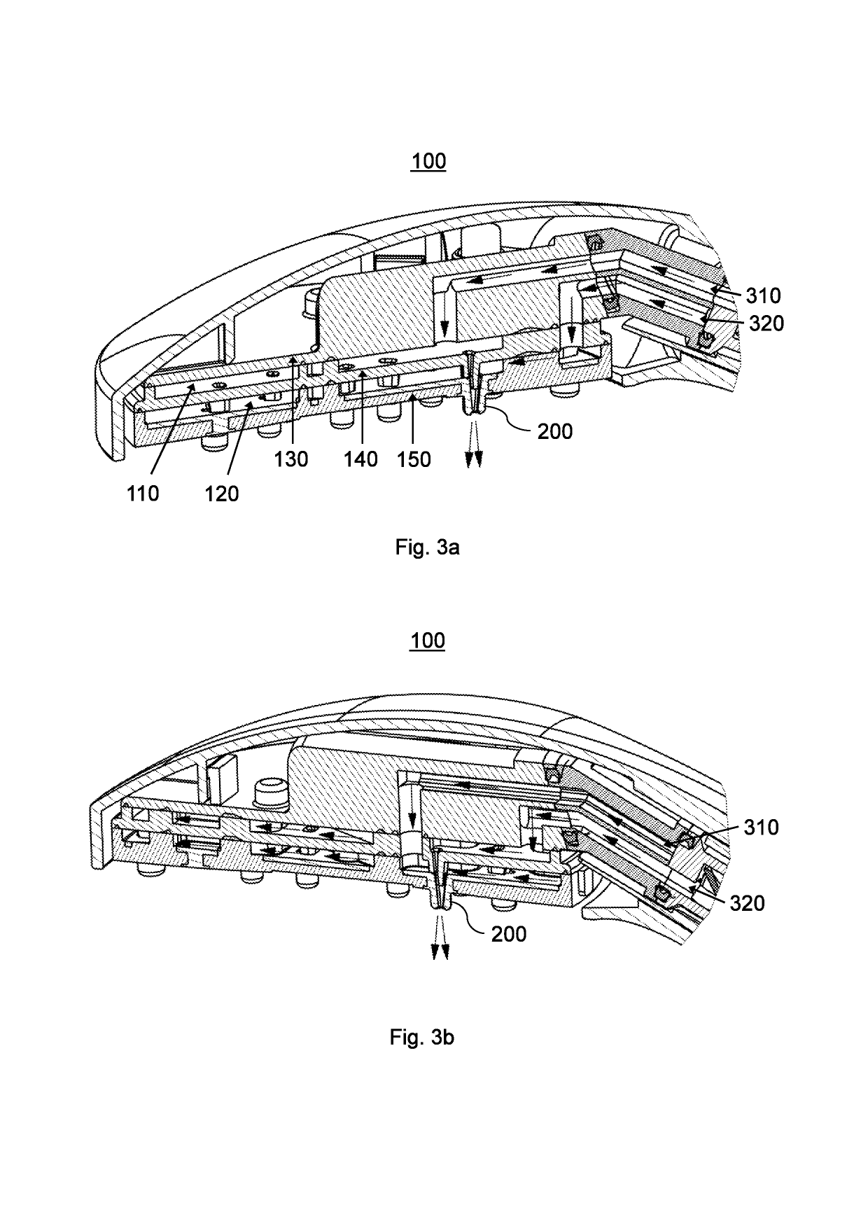

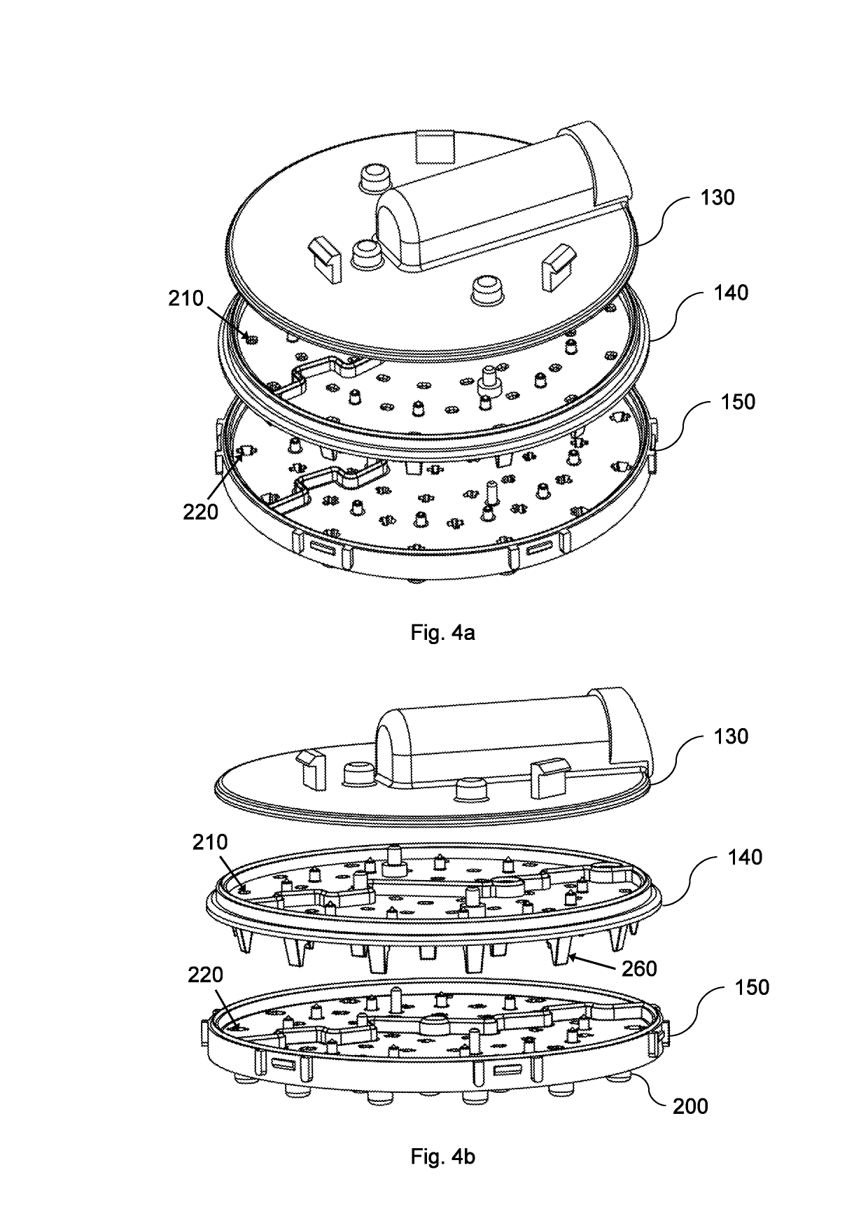

An example showerhead 100 is illustrated in FIGS. 1, 2a-b and 3a-b. A number of nozzles 200 are arranged in the showerhead 100. Example layers 130, 140, 150 and nozzles 200 of this example showerhead 100 are illustrated in FIGS. 4a-b, 5a-b and 6a-c. As illustrated in FIGS. 3a-3b, the nozzles 200 are directly connected to a first water inlet 310 via a first enclosed space 110, transversally arranged within the showerhead 100, and to a second water inlet 320 via the second enclosed space 120, also transversally arranged within the showerhead 100. The first enclosed space 110 and the second enclosed space 120 are both substantially parallel with a bottom layer 150 of the showerhead, through which the nozzles extend.

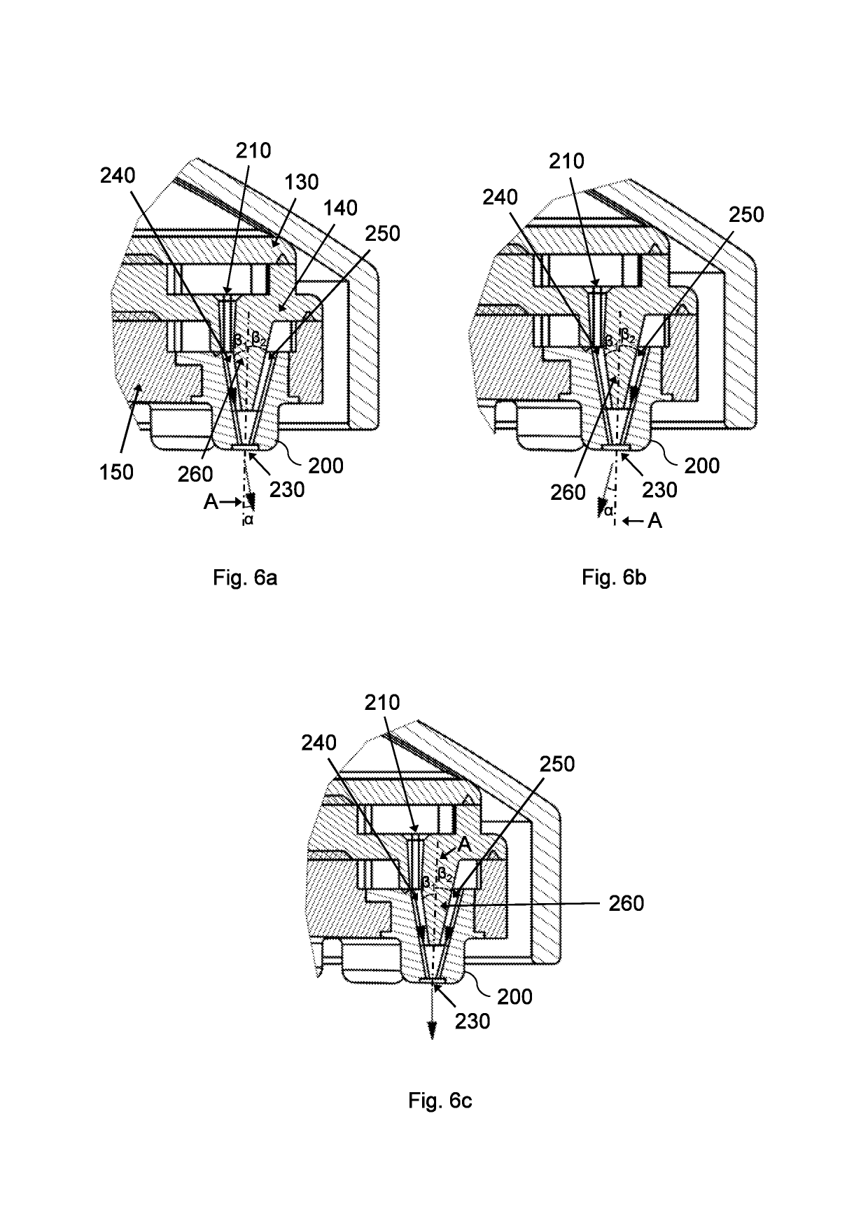

In the illustrated embodiment, the bottom layer is a lower layer 150, in which the nozzles are arranged. As illustrated in FIGS. 6a-c, each nozzle 200 has a first nozzle inlet 210, a second nozzle inlet 220, a nozzle outlet 230, a first nozzle channel 240, connecting the first nozzle inlet 210 with the nozzle outlet 230, and a second nozzle channel 250, connecting the second nozzle inlet 220 with the nozzle outlet 230.

In the illustrated nozzle 200, the first nozzle channel 240 is arranged at an angle β (=β₁+β₂) to the second nozzle channel 250. The nozzles 200 are configured so that the output angle α with respect to an axis A through the nozzle 200 of the water flowing out from each nozzle outlet 230 depends on whether water enters the nozzle 200 from only the first nozzle inlet 210, from only the second nozzle inlet 220, or from both nozzle inlets 210, 220.

If water enters the nozzle 200 from only the first nozzle inlet 210, the output angle α with respect to the axis A through the nozzle 200 of the water flowing out from the nozzle outlet 230 substantially corresponds to a channel angle β₁ of the first nozzle channel 240 with respect to the axis A through the nozzle 200. However, if the pressure of the water supplied to the first nozzle inlet 210 is low, the output angle will be less due to gravity.

If water enters the nozzle 200 from only the second nozzle inlet 220, the output angle α with respect to the axis A through the nozzle 200 of the water flowing out from the nozzle outlet 230 substantially corresponds to a channel angle β₂ of the second nozzle channel 250 with respect to the axis A through the nozzle 200. However, if the pressure of the water supplied to the second nozzle inlet 220 is low, the output angle will be less due to gravity.

If water enters the nozzle 200 from both the first nozzle inlet 210 and the second nozzle inlet 220, the output angle α with respect to the axis A through the nozzle 200 of the water flowing out from the nozzle outlet 230 is smaller than both the channel angle β₁ of the first nozzle channel 240 and the channel angle β₂ of the second nozzle channel 250. If the channel angle β₁ is substantially the same as the channel angle β₂, and the pressure of the water supplied to the first nozzle inlet 210 is substantially the same as the pressure of the water supplied to the second nozzle inlet 220, the water flowing out from the nozzle outlet 230 will be substantially parallel to the axis A through the nozzle 200.

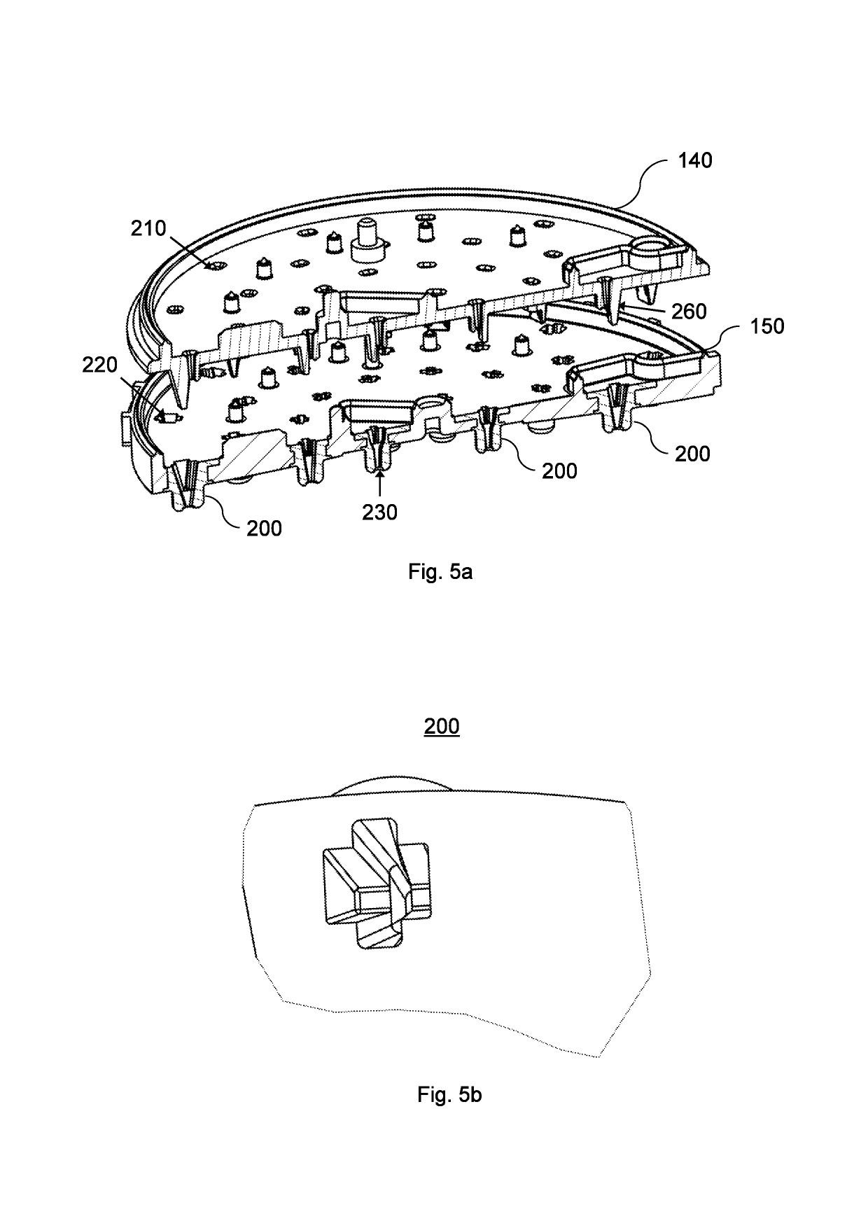

As shown in FIGS. 5a and 6a-c, a flow divider 260 may be arranged between the first 240 and second 250 nozzle channels, to help prevent water entering the first nozzle inlet 210 from entering the second nozzle channel 250, and that water entering the second nozzle inlet 220 cannot enter the first nozzle channel 240. This may help prevent water supplied to the first water inlet 310 from contaminating water supplied to the second 320 water inlet, or the other way around. The flow divider 260 may be integrated into the intermediate layer 140 or the lower layer 150.

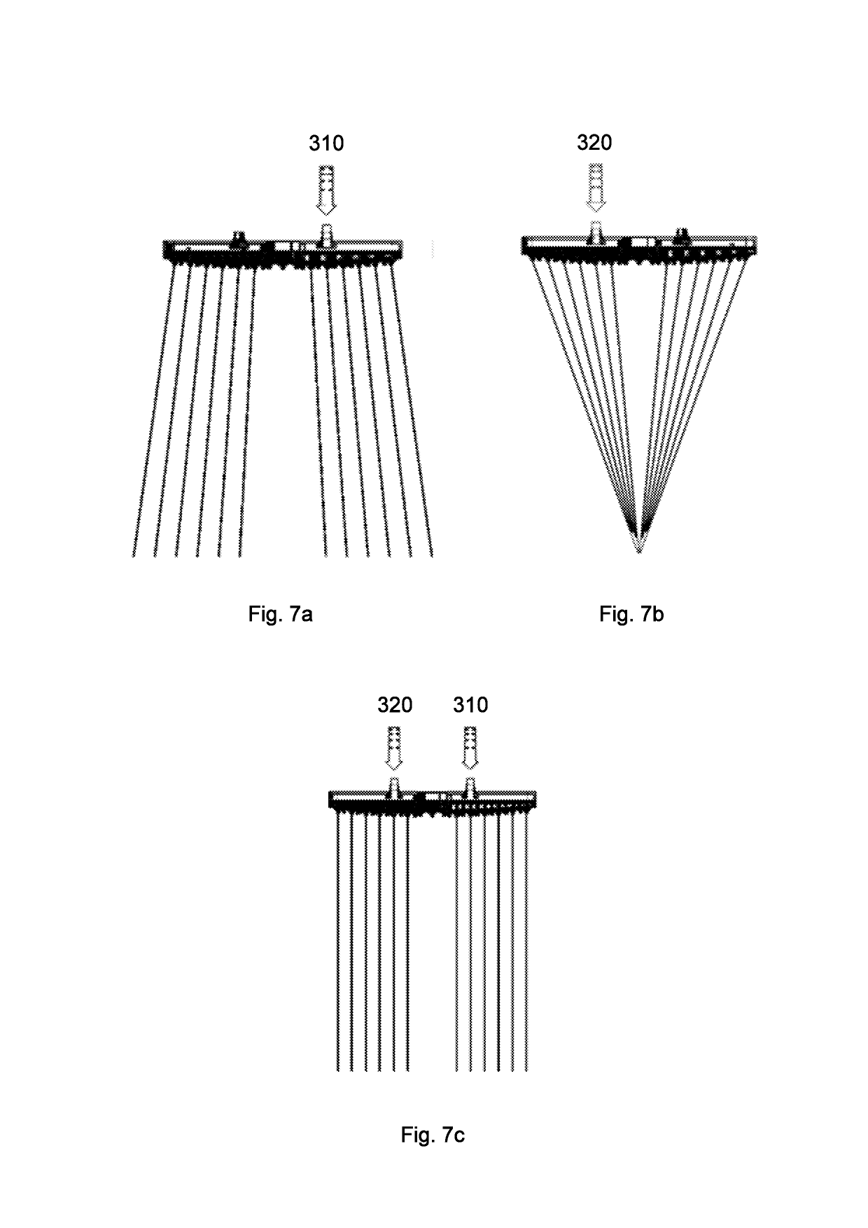

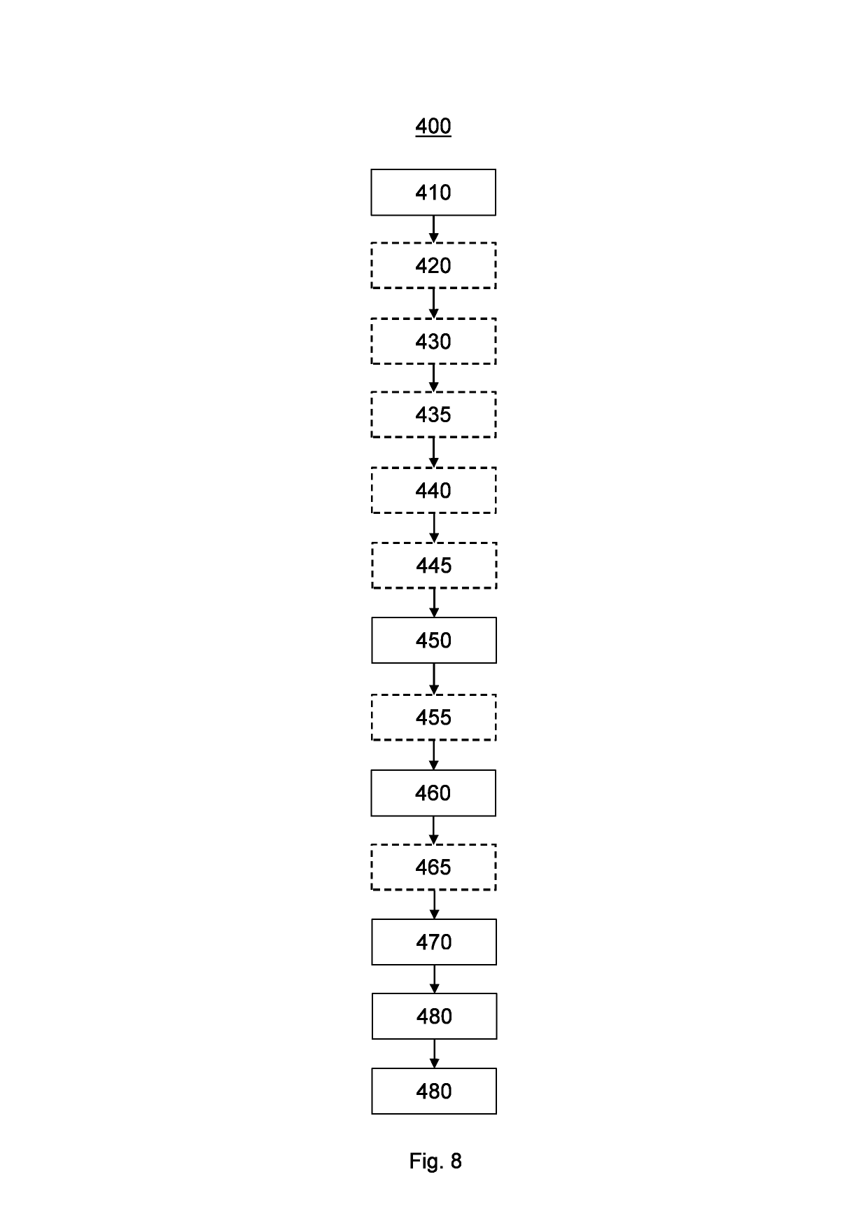

In order to control the output angle of water flowing out from the showerhead 100, all nozzles 200 may be arranged with the same one nozzle channel 240, 250 closer to a central area 270 of the lower layer 150 than the same other nozzle channel 240, 250. In the illustrated embodiment as seen in FIGS. 5a and 6a-c, the first nozzle channel 240 of all nozzles 200 is located closer to a central area 270 of the lower layer 150 than the second nozzle channel 250 of all nozzles 200. When water is supplied to only the first water inlet 310, and thereby to the first nozzle channel 240 of all nozzles 200, the output angle of water flowing out from the showerhead 100 will be directed outwards from the central area 270 of the lower layer 150, thus creating a wide shower spray pattern, as illustrated in FIG. 7a. When water is supplied to only the second water inlet 320, and thereby to the second nozzle channel 250 of all nozzles 200, the output angle of water flowing out from the showerhead 100 will be directed inwards toward the central area 270 of the lower layer 150, thus creating a focused shower spray pattern, as illustrated in FIG. 7b. If water is supplied to both the first water inlet 310 and the second water inlet 320, water may instead flow substantially straight out from the showerhead 100, as illustrated in FIG. 7c.

In the illustrated embodiment, all three layers 130, 140, 150 are disc-shaped, the first enclosed space 110 is formed between an upper layer 130 and an intermediate layer 140, and the second enclosed space 120 is formed between the intermediate layer 140 and a lower layer 150, but it may of course alternatively be the other way around (and the layers 130, 140, 150 do not have to be disc-shaped). The different layers 130, 140, 150 do not have to be separate constructions, two or more of them may be integral in one piece, but each layer 130, 140, 150 extends transversally across the showerhead 100 so that the first 110 and second 120 enclosed spaces are able to connect the first 310 and second 320 water inlets with the first 210 and second 220 nozzle inlets of all nozzles 200 having two inlets 210, 220. There may also be more layers in the showerhead 100.

As shown in FIG. 5a, the first nozzle inlets 210 may be integrated into the intermediate layer 140, and the second nozzle inlets 220 may be integrated into the lower layer 150.

In the illustrated embodiment, the first enclosed space 110 directly connects the first water inlet 310 to the first nozzle inlet 210 of each nozzle 200, and the second enclosed space 120 directly connects the second water inlet 320 to the second nozzle inlet 220 of each nozzle 200, but it may of course alternatively be the other way around.

The showerhead 100 may additionally have other nozzles, which do not have first 210 and second 220 nozzle inlets connected to the first 310 and second 320 water inlets.

The showerhead 100 may be a part of an ablutionary system which also includes a diverter arrangement. The diverter arrangement may be configured to be controllable to direct water to the first water inlet 310, to the second water inlet 320, or to both water inlets 310, 320. In the embodiment illustrated in FIG. 1, the diverter arrangement is integrated into the showerhead 100, and is controlled by a slider mechanism 350 arranged on the showerhead 100. An example of such a diverter arrangement is disclosed in US patent application 63/619,241. Alternatively, the diverter arrangement may be arranged remotely from the showerhead. The diverter arrangement may in embodiments be a digital valve in a shower control system.

FIG. 7 schematically illustrates a method 400 for controlling an output angle of water flowing out from a showerhead 100 of an ablutionary system. The method 400 may include:

Step 410: arranging a number of nozzles 200 in the showerhead 100. Each nozzle 200 may be configured to have: a first nozzle inlet 210; a second nozzle inlet 220, a nozzle outlet 230; a first nozzle channel 240, connecting the first nozzle inlet 210 with the nozzle outlet 230; and a second nozzle channel 250, arranged at an angle β (=β₁+β₂) to the first nozzle channel 240, and connecting the second nozzle inlet 220 with the nozzle outlet 230.

Step 450: arranging the showerhead 100 to have a first enclosed space 110, transversally arranged within the showerhead 100. The first enclosed space 110 may be substantially parallel with a bottom layer 150 of the showerhead, through which the nozzles 200 extend.

Step 460: arranging the showerhead 100 to have a second enclosed space 120, transversally arranged within the showerhead 100. The second enclosed space 120 may be substantially parallel with a bottom layer 150 of the showerhead, through which the nozzles 200 extend.

Step 470: arranging the first enclosed space 110 to directly connect a first water inlet 310 of the showerhead 100 to the first nozzle inlet 210 of each nozzle 200.

Step 480: arranging the second enclosed space 120 to directly connect a second water inlet 320 of the showerhead 100 to the second nozzle inlet 220 of each nozzle 200.

Step 490: controlling a diverter arrangement of the ablutionary system to allow water to flow into the first water inlet 310, and thereby into the first nozzle inlet 210, and/or into the second water inlet 320, and thereby into the second nozzle inlet 220. The output angle α with respect to an axis A through the nozzle 200 of the water flowing out from each nozzle outlet 230 depends on whether water enters the nozzle 200 from only the first nozzle inlet 210, from only the second nozzle inlet 220, or from both nozzle inlets 210, 220.

This enables a user to select between different angles of the water output from the nozzles 200, and thereby between different spray patterns.

In embodiments, if water enters the nozzle 200 from only the first nozzle inlet 210, the output angle α with respect to the axis A through the nozzle 200 of the water flowing out from the nozzle outlet 230 substantially corresponds to a channel angle β₁ of the first nozzle channel 240 with respect to the axis A through the nozzle 200; if water enters the nozzle 200 from only the second nozzle inlet 220, the output angle α with respect to the axis A through the nozzle 200 of the water flowing out from the nozzle outlet 230 substantially corresponds to a channel angle β₂ of the second nozzle channel 250 with respect to the axis A through the nozzle 200; and if water flows into the showerhead 100 from both the first water inlet 310 and the second water inlet 320, the output angle α with respect to the axis A through the nozzle 200 of the water flowing out from the nozzle outlet 230 is an angle that lies between the channel angle β₁ of the first nozzle channel 240 and the channel angle β₂ of the second nozzle channel 250. However, if the pressure of the water supplied to the either of the nozzle inlets is low, gravity may affect the output angles.

In embodiments, if water enters the nozzle 200 from both the first nozzle inlet 210 and the second nozzle inlet 220, the water flowing out from the nozzle outlet 230 is substantially parallel to the axis A through the nozzle 200. This may be the case at least if the channel angle β₁ is substantially the same as the channel angle β₂, and the pressure of the water supplied to the first nozzle inlet 210 is substantially the same as the pressure of the water supplied to the second nozzle inlet 220.

The method 400 may further include one or more of:

Step 420: arranging the intermediate layer 140 and the lower layer 150 to both be disc-shaped. This makes it easy to form the first enclosed space 110 between the upper layer 130 and the intermediate layer 140, and the second enclosed space 120 between the intermediate layer 140 and the lower layer 150.

Step 430: integrating the first nozzle inlets 210 into the intermediate layer 140. This connects the first nozzle 210 inlets to the first enclosed space 110. A flow divider 260 may also be integrated into the intermediate layer 140.

Step 435: integrating the second nozzle inlets 220 into the lower layer 150. This connects the second nozzle inlets 220 to the second enclosed space 220. A flow divider 260 may alternatively be integrated into the lower layer 150.

Step 440: arranging all nozzles 200 in the showerhead with the same one nozzle channel 240, 250 closer to a central area 270 of the lower layer 150 than the same other nozzle channel 240, 250. When water is supplied to only the first water inlet 310, and thereby to the first nozzle channel 210 of all nozzles 200, the output angle of water flowing out from the showerhead 100 will be directed outwards from the central area 270 of the lower layer 150, thus creating a wide shower spray pattern. When water is supplied to only the second water inlet 320, and thereby to the second nozzle channel 220 of all nozzles 200, the output angle of water flowing out from the showerhead 100 will be directed inwards toward the central area 270 of the lower layer 150, thus creating a focused shower spray pattern. If water is supplied to both the first water inlet 310 and the second water inlet 320, water may instead flow substantially straight out from the showerhead 100.

Step 445: arranging a flow divider 260 between the first 240 and second 250 nozzle channels, so that water entering the first nozzle inlet 210 cannot enter the second nozzle channel 250, and water entering the second nozzle inlet 220 cannot enter the first nozzle channel 240. This may help prevent water supplied to the first water inlet 310 contaminating water supplied to the second 320 water inlet, or the other way around.

Step 455: forming the first enclosed space 110 between an upper layer 130 and an intermediate layer 140 of the showerhead 100.

Step 465: forming the second enclosed space 120 between the intermediate layer 140 and a lower layer 150 of the showerhead 100.

The different layers 130, 140, 150 do not have to be separate constructions, two or more of them may be integral in one piece, but each layer 130, 140, 150 extends transversally across the showerhead 100 so that the first 110 and second 120 enclosed spaces are able to connect the first 310 and second 320 water inlets with the first 210 and second 220 nozzle inlets of all nozzles 200 having two inlets 210, 220. There may also be more layers in the showerhead 100.

The above steps may be effected in any order that makes technical sense. Some of the steps may also be effected simultaneously with each other.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Accordingly, the scope of the invention is defined only by the claims.

1. An ablutionary fitting comprising:
a first water inlet;
a second water inlet; and
a plurality of nozzles, each nozzle comprising:
a first nozzle inlet;
a second nozzle inlet;
a nozzle outlet;
a first nozzle channel connecting the first nozzle inlet with the nozzle outlet; and
a second nozzle channel arranged at an angle β to the first nozzle channel, and connecting the second nozzle inlet with the nozzle outlet,
wherein:
a first enclosed space, transversally arranged within the ablutionary fitting, directly connects the first water inlet to the first nozzle inlet of each nozzle;
a second enclosed space, transversally arranged within the ablutionary fitting , directly connects the second water inlet to the second nozzle inlet of each nozzle (200); and
an output angle α of each nozzle with respect to an axis A through the nozzle of the water flowing out from each nozzle outlet depends on whether water enters the nozzle from only the first nozzle inlet, from only the second nozzle inlet, or from both nozzle inlets.

2. The ablutionary fitting according to claim 1, wherein all nozzles are arranged with the first nozzle channel closer to a central area of the lower layer than the second nozzle channel.

3. The ablutionary fitting according to claim 1, wherein:
when water enters the nozzle from only the first nozzle inlet, an output angle α with respect to the axis A through the nozzle of the water flowing out from the nozzle outlet substantially corresponds to a channel angle β₁ of the first nozzle channel with respect to the axis A through the nozzle;
when water enters the nozzle from only the second nozzle inlet, the output angle α with respect to the axis A through the nozzle of the water flowing out from the nozzle outlet substantially corresponds to a channel angle β₂ of the second nozzle channel with respect to the axis A through the nozzle; and
when water enters the nozzle from both the first nozzle inlet and the second nozzle inlet, the output angle α with respect to the axis A through the nozzle of the water flowing out from the nozzle outlet is smaller than both the channel angle β₁ of the first nozzle channel and the channel angle β₂ of the second nozzle channel.

4. The ablutionary fitting according to claim 1, wherein when water enters the nozzle from both the first nozzle inlet and the second nozzle inlet, the water flowing out from the nozzle outlet is substantially parallel to the axis A through the nozzle.

5. The ablutionary fitting according to claim 1, wherein each nozzle comprises a flow divider that separates the first and second nozzle channels to prevent water entering the first nozzle inlet from entering the second nozzle channel, and water entering the second nozzle inlet from entering the first nozzle channel.

6. The ablutionary fitting according to claim 5, further comprising an upper layer, an intermediate layer and a lower layer, wherein the first enclosed space is formed between the upper layer and the intermediate layer, and the second enclosed space is formed between the intermediate layer and the lower layer.

7. The ablutionary fitting according to claim 6, wherein the first nozzle inlets are integrated into the intermediate layer, and the second nozzle inlets are integrated into the lower layer.

8. An ablutionary system comprising:
a showerhead comprising:
a first water inlet;
a second water inlet; and
a plurality of nozzles, each nozzle comprising:
a first nozzle inlet;
a second nozzle inlet;
a nozzle outlet;
a first nozzle channel connecting the first nozzle inlet with the nozzle outlet; and
a second nozzle channel arranged at an angle β to the first nozzle channel, and connecting the second nozzle inlet with the nozzle outlet,
wherein:
a first enclosed space, transversally arranged within the showerhead, directly connects the first water inlet to the first nozzle inlet of each nozzle;
a second enclosed space, transversally arranged within the showerhead, directly connects the second water inlet to the second nozzle inlet of each nozzle (200); and
an output angle α of each nozzle with respect to an axis A through the nozzle of the water flowing out from each nozzle outlet depends on whether water enters the nozzle from only the first nozzle inlet, from only the second nozzle inlet, or from both nozzle inlets;
a diverter arrangement,
wherein the diverter arrangement selectively directs water to the first water inlet, to the second water inlet, or to both water inlets.

9. The ablutionary system according to claim 8, wherein the diverter arrangement is integrated into the showerhead, and is controlled by a mechanism arranged on the showerhead.

10. A method comprising:
arranging a plurality of nozzles in a showerhead, where each nozzle comprises:
a first nozzle inlet;
a second nozzle inlet;
a nozzle outlet;
a first nozzle channel connecting the first nozzle inlet with the nozzle outlet; and
a second nozzle channel arranged at an angle β to the first nozzle channel, and connecting the second nozzle inlet with the nozzle outlet;
transversally arranging a first enclosed space within the showerhead;
transversally arranging a second enclosed space within the showerhead;
directly connecting a first water inlet of the showerhead to the first nozzle inlet of each nozzle via the first enclosed space;
directly connecting a second water inlet of the showerhead to the second nozzle inlet of each nozzle via the second enclosed space; and
controlling a diverter arrangement of the ablutionary system to allow water to flow into the first water inlet, and thereby into the first nozzle inlet, and/or into the second water inlet, and thereby into the second nozzle inlet;

11. The method according to claim 10, further comprising arranging all nozzles in the showerhead with the same one nozzle channel closer to a central area of the lower layer than the same other nozzle channel.

12. The method according to claim 10, wherein:
when water enters the nozzle from only the first nozzle inlet, the output angle α with respect to the axis A through the nozzle of the water flowing out from the nozzle outlet substantially corresponds to a channel angle β₁ of the first nozzle channel with respect to the axis A through the nozzle;
when water enters the nozzle from only the second nozzle inlet, the output angle α with respect to the axis A through the nozzle of the water flowing out from the nozzle outlet substantially corresponds to a channel angle β₂ of the second nozzle channel with respect to the axis A through the nozzle; and
when water enters the nozzle from both the first nozzle inlet and the second nozzle inlet, the output angle α with respect to the axis A through the nozzle of the water flowing out from the nozzle outlet is an angle that lies between the channel angle β₁ of the first nozzle channel and the channel angle β₂ of the second nozzle channel.

13. The method according claim 10, wherein when water enters the nozzle from both the first nozzle inlet and the second nozzle inlet, water flowing out from the nozzle outlet is substantially parallel to the axis A through the nozzle.

14. A method according to claim 10, further comprising:
forming the first enclosed space between an upper layer and an intermediate layer of the showerhead; and
forming the second enclosed space between the intermediate layer and a lower layer of the showerhead.

15. A method according to claim 14, further comprising integrating the first nozzle inlets into the intermediate layer, and integrating the second nozzle inlets into the lower layer.

16. The showerhead according to claim 6, wherein the intermediate layer and the lower layer are both disc-shaped.

17. The showerhead according to claim 7, wherein the flow divider is integrated into the intermediate layer or the lower layer.

18. The showerhead according to claim 14, wherein the intermediate layer and the lower layer are both disc-shaped.

19. The showerhead according to claim 15, wherein a flow divider is integrated into the intermediate layer or the lower layer.
